(19) United States
(12) Patent Application Publication
(10) Pub. No.: US 2023/0050889 A1
(43) Pub. Date: Feb. 16, 2023

(54) METHOD AND SYSTEM TO GENERATE KNOWLEDGE GRAPH AND SUB-GRAPH CLUSTERS TO PERFORM ROOT CAUSE ANALYSIS

(71) Applicant: Wipro Limited, Bangalore (IN)

(72) Inventors: Sendil KUMAR JAYA KUMAR, Bangalore (IN); Lakshya BHONDE, Dhar (IN)

(21) Appl. No.: 17/491,789

(22) Filed: Oct. 1, 2021

(30) Foreign Application Priority Data
Aug. 12, 2021 (IN) 202141036609

(51) Int. Cl. G06F 11/07; G06N 5/02; G06N 20/00; G06F 16/901

(52) U.S. Cl. CPC G06F 11/079; G06N 5/02; G06N 20/00; G06F 16/9024; G06F 16/9027

(57) ABSTRACT

Present invention discloses method and system for generating knowledge graph and sub-graph clusters to perform a root cause analysis. Method comprising extracting at least one of objects, data entities, links between the objects and the data entities, or relationships between the objects and the data entities from input content. Thereafter, method comprising generating a knowledge graph from the extracted data and sub-graphs from the knowledge graph using an unsupervised ML technique and extracting graph data structure information for each sub-graph. Subsequently, method comprising generating root cause model based on the sub-graphs and the graph data structure information and generating at least one sub-graph cluster and corresponding probabilistic graphical model using the root cause model and the knowledge graph. Generated Knowledge graph, root cause model and at least one sub-graph cluster and corresponding probabilistic graphical model are used to determine a root cause for an issue from an issue content.

### TECHNICAL FIELD

The present subject matter is generally related to Root Cause Analysis (RCA), more particularly, but not exclusively, to a method and an RCA system for generating a knowledge graph and sub-graph clusters to perform an RCA.

### BACKGROUND

Root Cause Analysis (RCA) is a structured problem processing mechanism to detect cause of a problem, identify the solution to the problem, and taking preventive measures. The conventional RCA mechanisms perform static analysis, has single dimension, and cannot carry out synchronous acquisition and diagnosis on a plurality of data sources. Further, human expertise is required to design and develop an RCA engine for any given domain, thus, making it a tedious process. This makes the RCA engine to be dependent on the historical data trends on each RCA analysis, thus, allowing the RCA engine to detect only the existing RCA factors. For example, RCA from the unstructured text requires human resources to physically read the feedback associated with the variation and to then make inferences on which specific issues have caused the variation. Such approach is time consuming and any delay in identifying issues may translate into a serious issue at a later stage and/or loss of potential revenue. Further, the conventional mechanisms are labor intensive, inconsistent, error-prone, and tend to be influenced by subjective judgement. For instance, on 5G network operations, there is huge amount of data that needs to be performed. The experts may not be able to understand all the problems in the 5G network. Also, the 5G networks are evolving based on demand and configuration with respect to environment. This requires quite a lot of analysis to understand the parameter, Key Performance Indicator (KPI), and their impact. Further, some issues in 5G are known and few are under investigation by experts to confirm the facts of the issue, which needs to be proved. However, in many cases, the issue of facts for RCA is unknown.

Conventional mechanisms on RCA are driven by events and correlation of events. The events correlation results in the prediction of new issue condition. Such mechanisms result in hardcoding the known RCA into the system based on event correlation. Such solution on RCA is static in nature. Consequently, the solution does not allow new root cause to be dynamically introduced, thereby, does not provide an opportunity for a dynamic root cause analysis system to be evolved from the data without human or experts' intervention.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure relates to a method of generating a knowledge graph and sub-graph clusters to perform a root cause analysis. The method includes extracting at least one of one or more objects, one or more data entities, links between the one or more objects and the one or more data entities, or relationships between the one or more objects and the one or more data entities from a received input content. Thereafter, the method comprising generating a knowledge graph based on the at least one of the one or more objects, the one or more data entities, the links between the one or more objects and the one or more data entities, or the relationships between the one or more objects and the one or more data entities using an unsupervised machine learning technique. Subsequently, the method comprising generating a set of sub-graphs from the knowledge graph based on a number of node connections in the knowledge graph using the unsupervised machine learning technique, extracting graph data structure information for each sub-graph in the set of sub-graphs and generating a root cause model based on the set of sub-graphs and the graph data structure information for each sub-graph using a graph convolutional network. Lastly, the method comprising generating at least one sub-graph cluster and corresponding probabilistic graphical model using the root cause model and the knowledge graph, wherein a sub-graph cluster is a collection of sub-graphs relating to a sub-domain. The knowledge graph, the root cause model and information related to the at least one sub-graph cluster and corresponding probabilistic graphical model for each of the sub-graph cluster are used to determine a root cause for an issue from an issue content.

In an embodiment, the present disclosure relates to a Root Cause Analysis (RCA) system for generating a knowledge graph and sub-graph clusters to perform a root cause analysis. The RCA system may include a processor and a memory communicatively coupled to the processor, wherein the memory stores processor-executable instructions, which on execution, cause the processor to extract at least one of one or more objects, one or more data entities, links between the one or more objects and the one or more data entities, or relationships between the one or more objects and the one or more data entities from a received input content. Thereafter, the processor is configured to generate a knowledge graph based on the at least one of the one or more objects, the one or more data entities, the links between the one or more objects and the one or more data entities, or the relationships between the one or more objects and the one or more data entities using an unsupervised machine learning technique. Subsequently, the processor is configured to generate a set of sub-graphs from the knowledge graph based on a number of node connection in the knowledge graph using the unsupervised machine learning technique, extract graph data structure information for each sub-graph in the set of sub-graphs, and generate a root cause model based on the set of sub-graphs and the graph data structure information for each sub-graph using a graph convolutional network. Lastly, the processor is configured to generate at least one sub-graph cluster and corresponding probabilistic graphical model using the root cause model and the knowledge graph, wherein a sub-graph cluster is a collection of sub-graphs relating to a sub-domain. The knowledge graph, the root cause model and information related to the at least one sub-graph cluster and corresponding probabilistic graphical model for each of the sub-graph cluster are used to determine a root cause for an issue from an issue content.

In an embodiment, the present disclosure relates to a non-transitory computer readable medium including instructions stored thereon that when processed by at least one processor cause a Root Cause Analysis (RCA) system to perform operations comprising extracting at least one of one or more objects, one or more data entities, links between the one or more objects and the one or more data entities, or relationships between the one or more objects and the one or more data entities from a received input content. Thereafter, the instructions when processed by the at least one processor cause the RCA system to perform operations comprising generating a knowledge graph based on the at least one of the one or more objects, the one or more data entities, the links between the one or more objects and the one or more data entities, or the relationships between the one or more objects and the one or more data entities using an unsupervised machine learning technique. Subsequently, the instructions when processed by the at least one processor cause the RCA system to perform operations comprising generating a set of sub-graphs from the knowledge graph based on a number of node connections in the knowledge graph using the unsupervised machine learning technique, extracting graph data structure information for each sub-graph in the set of sub-graphs and generating a root cause model based on the set of sub-graphs and the graph data structure information for each sub-graph using a graph convolutional network. Lastly, the instructions when processed by the at least one processor cause the RCA system to perform operations comprising generating at least one sub-graph cluster and corresponding probabilistic graphical model using the root cause model and the knowledge graph, wherein a sub-graph cluster is a collection of sub-graphs relating to a sub-domain. The knowledge graph, the root cause model and information related to the at least one sub-graph cluster and corresponding probabilistic graphical model for each of the sub-graph cluster are used to determine a root cause for an issue from an issue content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1a illustrates an exemplary environment for generating a knowledge graph and sub-graph clusters to perform a root cause analysis in accordance with some embodiments of the present disclosure.

FIG. 1b illustrates an exemplary example of parts of speech classification in accordance with some embodiments of the present disclosure.

FIGS. 1c-A and 1c-B illustrate an exemplary example of a detailed classification of parts of speech in accordance with some embodiments of the present disclosure.

FIG. 1d illustrates an exemplary example of a knowledge graph in accordance with some embodiments of the present disclosure.

FIGS. 1e-1g illustrate exemplary examples of sub-graph clusters in accordance with some embodiments of the present disclosure.

FIG. 1h illustrates an exemplary example of a root cause analysis for an issue in accordance with some embodiments of the present disclosure.

FIG. 2 shows a detailed block diagram of a root cause analysis system in accordance with some embodiments of the present disclosure.

FIG. 3a illustrates a flowchart showing a method of generating a knowledge graph and sub-graph clusters to perform a root cause analysis in accordance with some embodiments of present disclosure.

FIG. 3b illustrates a flowchart showing a method of performing a root cause analysis using the method illustrated in FIG. 3a in accordance with some embodiments of present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure provides an improved and efficient method and an RCA system that dynamically performs knowledge graph and sub-graph clusters based RCA. The solution provided by the present disclosure has the automation capability to learn (technical and/or business) domain and generate the causes for failure by using the unsupervised machine learning technique. The domain learning is represented in terms of knowledge graph and sub-graph clusters. The present disclosure processes received input content to extract a set of features in order to generate a knowledge graph and thereafter, a set of sub-graphs from the knowledge graph. The knowledge graph and sub-graphs help to build the domain knowledge. Using the generated knowledge graph and the sub-graphs, the graph data structures are extracted. The extracted graph data structures from the knowledge graph and the sub-graphs are processed to generate sub-graph cluster(s) and corresponding probabilistic graphical model. The probabilistic graphical model helps to determine the core problems that led to the root cause analysis and act as a core root cause classifier. Once the core root cause is determined, a probabilistic graphical model is built for each cluster that is available in the core root cause classifier. Thereafter, whenever, an issue content containing an issue is received, the present disclosure determines a root cause for the issue using the knowledge graph, the root cause model and information related to the at least one sub-graph cluster and corresponding probabilistic graphical model for each of the sub-graph cluster. The approach presented in the present disclosure has following technical advantages: (1) the present disclosure provides a generic RCA solution to cater to all technical and/or business problems irrespective of their domain, (2) the present disclosure intuitively learns new RCA findings while processing and also, learns the unknown facts and derive new facts that are not known during the training phase, and (3) the present disclosure applies unsupervised machine learning technique along with knowledge graph and sub-graph clusters for adapting to the changes that evolves in the technical and/or business domain environment.

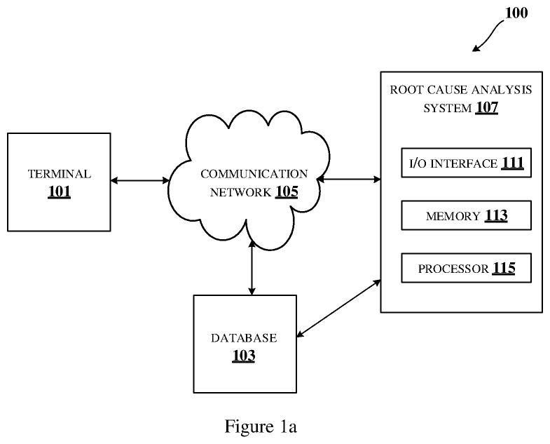

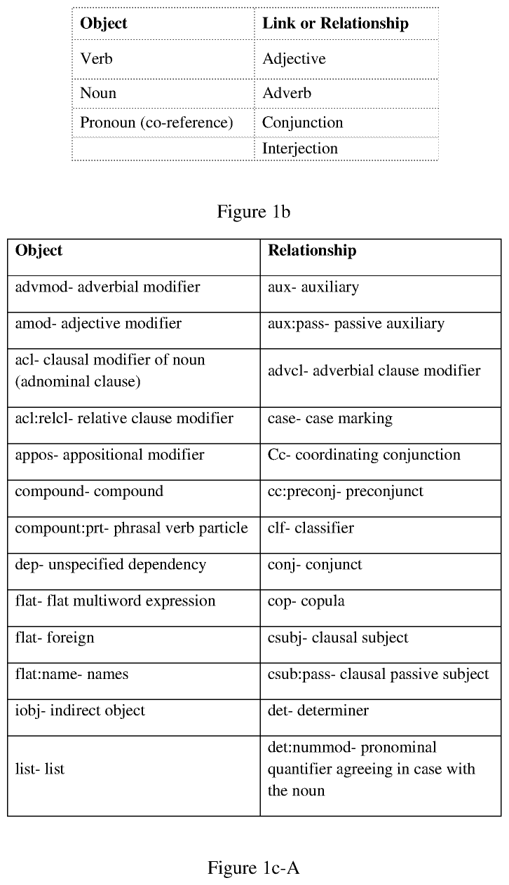

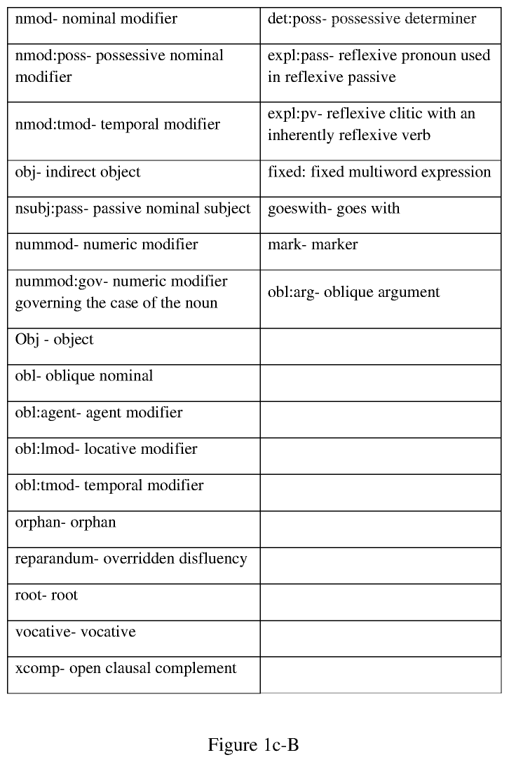

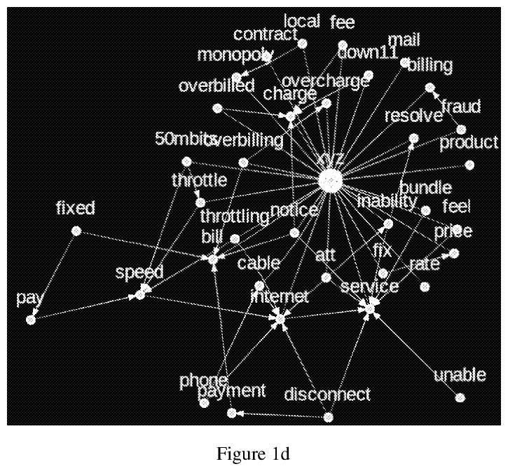

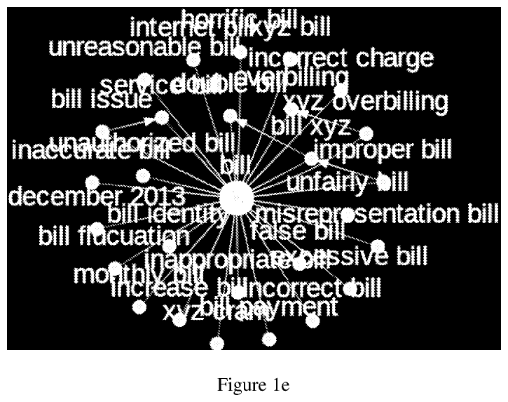

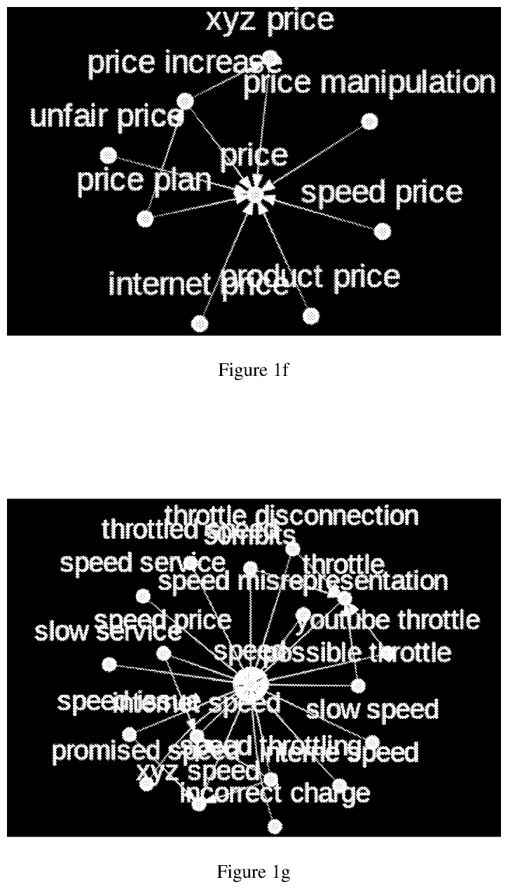

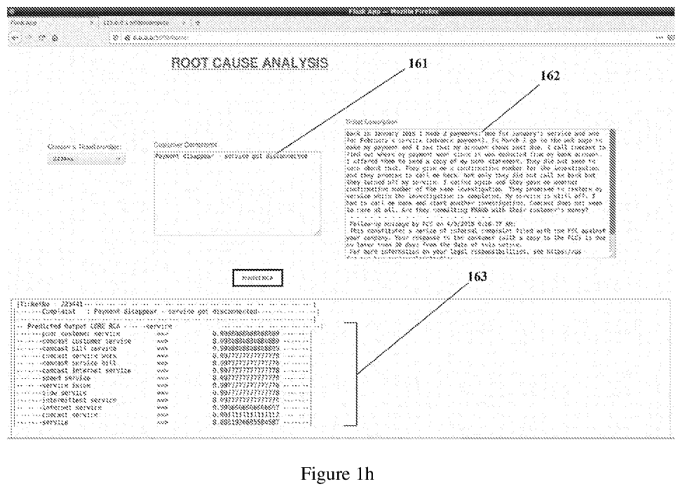

FIG. 1a illustrates an exemplary environment for generating a knowledge graph and sub-graph clusters to perform a Root Cause Analysis (RCA) in accordance with some embodiments of the present disclosure.

As shown in the FIG. 1a, the environment 100 includes a terminal 101, a database (also, referred as repository) 103, a communication network 105 and an RCA system 107. The terminal 101 and the database 103 may be a part of one or more data sources that provide at least one of an input content and an issue content to the RCA system 107 via the communication network 105. The terminal 101 may be any electronic device such as, but not limited to, a computer, a laptop, a mobile device and the like that a user may use to provide the input content and/or the issue content. The input content may comprise at least one of a customer complaint ticket content, a product application log content, a device execution log content, or a text corpus. The text corpus may comprise at least one of a product documentation, a product specification, a product feature, a product manual, product support information with issues and resolutions or a troubleshooting procedure. Whereas the issue content may comprise at least one of the customer complaint ticket content, the product application log content, or the device execution log content. The terminal 101 and the database 103 may communicate with the RCA system 107 using the communication network 105 using any of the following, but is not limited to, communication protocols/methods: a direct interconnection, an e-commerce network, a Peer-to-Peer (P2P) network, Local Area Network (LAN), Wide Area Network (WAN), wireless network (for example, using Wireless Application Protocol), Internet, Wi-Fi, Bluetooth and the like.

In the embodiment, the RCA system 107 may include an Input/Output (I/O) interface 111, a memory 113, and a processor 115. The I/O interface 111 may be configured to receive at least one of an input content and an issue content from the terminal 101 and/or the database 103. The I/O interface 111 may employ communication protocols/methods such as, without limitation, audio, analog, digital, monaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

At least one of an input content and an issue content received by the I/O interface 111 may be stored in the memory 113. The memory 113 may be communicatively coupled to the processor 115 of the RCA system 107. The memory 113 may, also, store processor-executable instructions which may cause the processor to execute the instructions for generating a knowledge graph and sub-graph clusters to perform an RCA. The memory 113 may include, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 115 may include at least one data processor for generating a knowledge graph and sub-graph clusters to perform an RCA. The processor 115 may include specialized processing units such as integrated system (bus) controllers, memory management control units, floating point units, graphics processing units, digital signal processing units, etc.

The database 103 may be updated at pre-defined intervals of time. These updates may be related to the input content comprising at least one of a customer complaint ticket content, a product application log content, a device execution log content, or a text corpus for adaptive learning.

Hereinafter, the operation of the RCA system 107 is explained in two parts: (1) first part explains the RCA system 107 for generating a knowledge graph and sub-graph clusters to perform an RCA, and (2) second part explains the RCA system 107 for determining a root cause for an issue using the generated knowledge graph and sub-graph clusters.

The first part of the RCA system 107 for generating a knowledge graph and sub-graph clusters to perform an RCA may also be referred as training phase. The RCA system 107 receives an input content from at least one of the terminal 101 and the database 103 via the communication network 105. The received input content comprises at least one of a customer complaint ticket content, a product application log content, a device execution log content, or a text corpus. Furthermore, the text corpus comprises at least one of a product documentation, a product specification, a product feature, a product manual, product support information with issues and resolutions, or a troubleshooting procedure. After receiving the input content, the RCA system 107 pre-processes the input content by removing stop words and performing keyword processing and lemmatization. In detail, the RCA system 107 extracts/pre-processes at least one of one or more objects, one or more data entities, links between the one or more objects and the one or more data entities, or relationships between the one or more objects and the one or more data entities from the received input content. The part of speech in the received input content is used to extract the object, link, and relationship. Here, the link refers to probabilistic dependencies between objects (keywords) and the relationship refers to association between objects (keywords) as seen as cause and effect that yields relationship. Both the probabilistic dependencies and the association are measured by Bayesian Network. During the training phase, the link and the relationship are learnt. By doing so the association between cause and effect is learnt indirectly. The associations are further refined/enriched by noise elimination, removal of stop words, by ranking, and by keywords detection. This results in domain modelling with respect to cause and effect. Whereas, during an RCA phase or an issue resolving phase, only issue is seen and the probability of cause and effect against the issue with the help of Bayesian network using Conditional Probability Distribution (CPD) is determined. In detail, the RCA system 107 extract the at least one of one or more objects, one or more data entities, links between the one or more objects and the one or more data entities, or relationships between the one or more objects and the one or more data entities against each list of words in sentences in the received input content.

FIG. 1b shows an example of parts of speech classification and this information is extracted from the input content. A detailed classification of parts of speech, the information extracted from the input content, is shown in FIGS. 1c-A and 1c-B.

Thereafter, the RCA system 107 generates a knowledge graph based on the at least one of the one or more objects, the one or more data entities, the links between the one or more objects and the one or more data entities, or the relationships between the one or more objects and the one or more data entities using an unsupervised machine learning technique. In detail, the RCA system 107 computes cosine similarity between each of the at least one of the one or more objects, the one or more data entities, the links between the one or more objects and the one or more data entities and the relationships between the one or more objects and the one or more data entities. The computation of cosine similarity allows understanding the text semantic i.e., to understand sentences in the received input content by analysing their grammatical structure and identifying relationships between individual words in a particular context. The computation of cosine similarity approach helps to estimate the degree of similarity between the entity, the object, the link, and the relationship. In next step, the RCA system 107 aggregates at least one object and at least one data entity based on the computation. In detail, using the parts of speech classification, the RCA system 107 aggregates the related nouns that are detected as the objects along with the entities. Subsequently, the RCA system 107 determines relationship between the at least one object and the at least one data entity based on the aggregated at least one object and the at least one data entity to generate a plurality of directed acyclic graphs. The directed acyclic graph indicates a connection between an object of the one or more objects and a data entity of the one or more data entities based on their relationship. The object is a source node and the data entity is a target node in the directed acyclic graph. Using the parts of speech classification, the relationship with each of the nodes are, also, linked. This helps to create a complete web of nodes with the links and relationships with data entities of the objects. In the next step, the RCA system 107 generates a dynamic data tree structure using the plurality of directed acyclic graphs to generate the knowledge graph. The generated knowledge graph automatically yields object names (also, referred as labels) such as bill, internet, service and the like as shown in FIG. 1d with respect to the domain. This results in unsupervised learning. The dynamic data tree structure acts as the knowledge graph with the nodes carrying varying attribute information. In an embodiment, each node in the dynamic data tree structure contains a weightage score as an attribute information. The weightage score is based on the cosine distance and the summarized occurrence count of the nodes at the source input. In an embodiment, the RCA system 107 filters nodes with less than a pre-determined number of node connections in the dynamic data tree structure. The nodes with less than the pre-determined number of node connections may act as a noise content. The pre-determined number of node connections may be set to, but not limited to, two or three. The dynamic data tree structure results in the knowledge graph generation. In an embodiment, the generated knowledge graph includes collections of nodes where each node includes attributes to represent the node. Furthermore, the generated knowledge graph includes the at least one of the one or more objects, the one or more data entities, the links between the one or more objects and the one or more data entities, or the relationships between the one or more objects and the one or more data entities. An exemplary example of a knowledge graph is shown in FIG. 1d. Each of the objects, for instance, xyz (here “xyz” is the name of an organisation), bill, internet, service and the like is represented by the nodes. The direction of the arrow shows the nature or order of the link and relationship. The generated knowledge graph, also, discovers the hidden domain knowledge with its links and relationships using the learning made by the knowledge graph over its input domain that is learned using the unsupervised machine learning technique.

Subsequently, the RCA system 107 generates a set of sub-graphs from the knowledge graph based on a number of node connections in the knowledge graph using the unsupervised machine learning technique. In detail, the node with the maximum number of node connections is analysed. The node with higher number of node connections may evolve due to the higher amount of activity that is carried out in the domain. This is learned dynamically from the data without any human intervention or expert's intervention. In the knowledge graph, each node and the number of node connections are analysed by the RCA system 107. In one embodiment, the nodes with more than 5 node connections are considered to build a bell curve. The bell curve provides intuition with list of nodes that are very highly connected nodes, highly connected nodes, average connected nodes, low connected nodes, and very low connected nodes. For each of the nodes in the list of nodes, the RCA system 107 analyses the (selected) nodes and its features i.e., the at least one of the one or more objects, the one or more data entities, the links between the one or more objects and the one or more data entities, or the relationships between the one or more objects and the one or more data entities and then clustered into a sub-graph. For example, FIGS. 1e-1g illustrate 3 different sub-graph nodes that contain maximum relationships being identified. The 3 different sub-graph nodes generated out of the knowledge graph are the bill sub-graph (shown in FIG. 1e), the service sub-graph (shown in FIG. 1f), and the speed sub-graph (shown in FIG. 1g). In each of the sub-graphs, the core node has the maximum relationships with the related neighbourhood node. In an embodiment, the RCA system 107 filters the nodes with less than 2 link connections, which are considered as weak relationships and/or noisy nodes. As an example, with reference to bill sub-graph (shown in FIG. 1e), the RCA system 107 discovers various relationships such as how the core node bill is linked with other related nodes like bill issues, improper, unfairly bill, overbilling, incorrect charge, and the like. The RCA system 107 discovers these relationships using the unsupervised machine learning technique without any consideration towards the domain. Analogously, the RCA system 107 discovers various relationships between the core node and sub-nodes for the service sub-graph (shown in FIG. 1f), and the speed sub-graph (shown in FIG. 1g) using the unsupervised machine learning technique without any consideration towards the domain.

In the next step, the RCA system 107 extracts graph data structure information for each sub-graph in the set of sub-graphs. To extract graph data structure information, the RCA system 107 looks for the nodes with highest number of connectivity with respect to link and relationship. For example, if more than 10 node connections are detected, then the RCA system 107 qualifies them as a sub-graph. The extracted graph data structure is used by the RCA system 107 in training and generating the probabilistic graphical models. The graph data structure information presents the training content to the RCA system 107. In an embodiment, the RCA system 107 is designed and built based on the probabilistic inference and is driven by the data to provide the statistical inferences. Further, for each sub-graph, the RCA system 107 generates the probabilistic inference structure model. For example, 3 different probabilistic inference structure models are generated for each sub-graph i.e., the bill sub-graph (shown in FIG. 1e), the service sub-graph (shown in FIG. 1f), and the speed sub-graph (shown in FIG. 1g).

The RCA system 107 generates a root cause model based on the set of sub-graphs and the graph data structure information for each sub-graph using a graph convolutional network. In detail, using the graph convolutional network along with the set of sub-graphs and the graph data structure information, the RCA system 107 trains and generates the root cause model. The root cause model represents the entire domain. The root cause model helps to predict the core problem in the input content. This core problem prediction helps in identifying the respective sub-graph where further analysis is performed by the RCA system 107 to determine the cause and effect.

In the next step, the RCA system 107 generates at least one sub-graph cluster and corresponding probabilistic graphical model using the root cause model and the knowledge graph. A sub-graph cluster is a collection of sub-graphs relating to a sub-domain. In detail, the nodes with maximum number of connections with its neighbourhood or core nodes are analysed. The RCA system 107 determines sub-graph cluster based on the maximized number of node connections. A threshold on maximized number of node connections that are configured in sub-graph generation is used/applied here. The threshold is used to detect new sub-graph clusters if the connection size on number of nodes exceeds the threshold. After detecting the new sub-graph cluster, the probabilistic graphical model is trained for each of the detected new sub-graph cluster. The probabilistic graphical model is trained on the conditional probability distributions and on likelihood estimation. Thereafter, the RCA system 107 assigns weightage factor for the at least one sub-graph cluster using a trained probabilistic graphical model. The weightage factor is based on the list of factors that led to RCA. The list of factors includes link i.e., probabilistic dependencies between objects (keywords) and relationship i.e., association between objects (keywords) as seen as cause and effect that yields relationship derived from Bayesian Network using Conditional Probability Distribution (CPD). The training of probabilistic graphical model and assigning weightage factor for the at least one sub-graph cluster are repeated to all detected clusters. This results in an array of sub-graphs with the probabilistic inferences. The knowledge graph, the root cause model and information related to the at least one sub-graph cluster and corresponding probabilistic graphical model for each of the sub-graph cluster are later used to determine a root cause for an issue from an issue content.

At the end of training phase i.e., generating a knowledge graph and sub-graph clusters to perform an RCA, the RCA system 107 stores at least one of the knowledge graph, the root cause model and the information related to the at least one sub-graph cluster and the corresponding probabilistic graphical model for each of the sub-graph cluster in the database 103.

The second part of the RCA system 107 for determining a root cause for an issue using the generated knowledge graph and sub-graph clusters may, also, be referred as RCA phase or issue resolving phase.

The RCA system 107 receives the issue content from one or more data sources. The issue content comprises at least one of a customer complaint ticket content, a product application log content, or a device execution log content.

After receiving the issue content, the RCA system 107 pre-processes the input content by removing stop words and performing keyword processing and lemmatization. In detail, the RCA system 107 extracts/pre-processes a plurality of features comprising a set of objects, a set of data entities, links between each object and each data entity, and relationships between each object and each data entity from the received issue content.

Lastly, the RCA system 107 determines a root cause for an issue from the extracted plurality of features using the knowledge graph, the root cause model and information related to the at least one sub-graph cluster and corresponding probabilistic graphical model for each of the sub-graph cluster stored in the database 103. In detail, the RCA system 107 receives the stored information such as the knowledge graph, the root cause model and information related to the at least one sub-graph cluster and corresponding probabilistic graphical model for each of the sub-graph cluster from the database 103. After receiving the stored information, the RCA system 107 determines the (core) root cause against the issue that is received in the issue content. This represents an intermediate output that provides the indication on the next step sub-graph cluster that needs to be executed in order to determine the causes or facts that led to the problem/issue. After determining the (core) root cause, the RCA system 107 identifies the sub-graphs associated with the (core) root cause and determines a list of issues associated with the root cause. In one embodiment, the root causes for an issue are ranked by computing the conditional probability distribution values. For example, the conditional probability distribution values are ranged from 0.0 to 0.9999, which act like weighted scores. An example of the RCA system 107 determining a root cause for an issue is shown in FIG. 1h. Reference 161 shows an issue content containing an issue raised by a customer (or a user) and reference 162 shows corresponding complaint ticket description given by the customer (or the user). The RCA system 107 determining a root cause for the issue in the form of a list of issues ranked by computing the conditional probability distribution values is shown as reference 163.

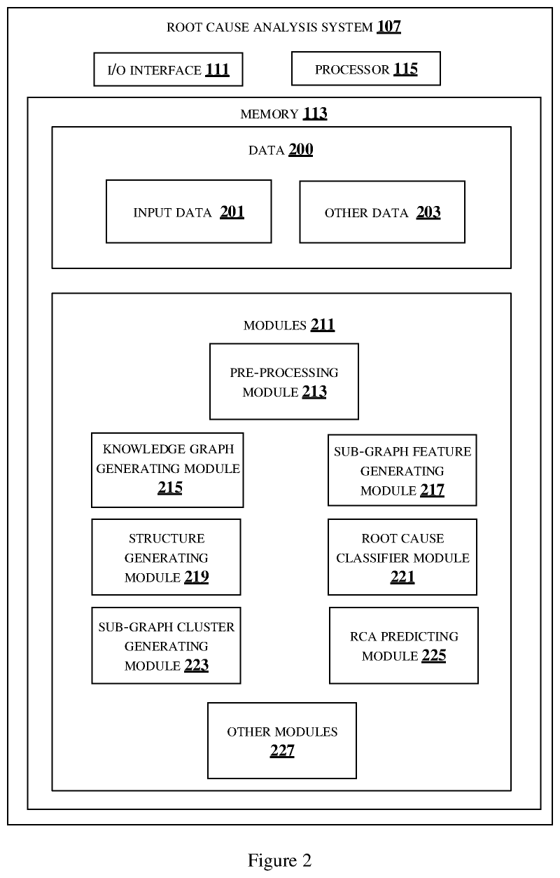

FIG. 2 shows a detailed block diagram of an RCA system in accordance with some embodiments of the present disclosure.

The RCA system 107, in addition to the I/O interface 111 and processor 115 described above, may include data 200 and one or more modules 211, which are described herein in detail. In the embodiment, the data 200 may be stored within the memory 113. The data 200 may include, for example, input data 201 and other data 203.

The input data 201 may include at least one of an input content and an issue content received from one or more data sources such as the terminal 101 and/or the database 103.

The other data 203 may store data, including temporary data and temporary files, generated by one or more modules 211 for performing the various functions of the RCA system 107.

In the embodiment, the data 200 in the memory 113 are processed by the one or more modules 211 present within the memory 113 of the RCA system 107. In the embodiment, the one or more modules 211 may be implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the RCA system 107. The said modules 211 when configured with the functionality defined in the present disclosure will result in a novel hardware.

In one implementation, the one or more modules 211 may include, but are not limited to, a pre-processing module 213, a knowledge graph generating module 215, a sub-graph feature generating module 217, a structure generating module 219, a root cause classifier module 221, a sub-graph cluster generating module 223, and an RCA predicting module 225. The one or more modules 211 may, also, include other modules 227 to perform various miscellaneous functionalities of the RCA system 107.

The pre-processing module 213, during training phase, receives an input content from one or more data sources such as the terminal 101 and/or the database 103 via the communication network 105. The received input content comprises at least one of a customer complaint ticket content, a product application log content, a device execution log content, or a text corpus. Furthermore, the text corpus comprises at least one of a product documentation, a product specification, a product feature, a product manual, product support information with issues and resolutions, or a troubleshooting procedure. After receiving the input content, the pre-processing module 213 pre-processes the input content by removing stop words and performing keyword processing and lemmatization. The pre-processing module 213 extracts/pre-processes at least one of one or more objects, one or more data entities, links between the one or more objects and the one or more data entities, or relationships between the one or more objects and the one or more data entities from the received input content.

The pre-processing module 213, during RCA phase or issue resolving phase, receives an issue content from one or more data sources such as the terminal 101 and/or the database 103. The issue content comprises at least one of a customer complaint ticket content, a product application log content, or a device execution log content. After receiving the issue content, the pre-processing module 213 pre-processes the input content by removing stop words and performing keyword processing and lemmatization. The pre-processing module 213 extracts/pre-processes a plurality of features comprising a set of objects, a set of data entities, links between each object and each data entity, and relationships between each object and each data entity from the received issue content.

The knowledge graph generating module 215 generates a knowledge graph based on the at least one of the one or more objects, the one or more data entities, the links between the one or more objects and the one or more data entities, or the relationships between the one or more objects and the one or more data entities using an unsupervised machine learning technique. In detail, the knowledge graph generating module 215 computes cosine similarity between each of the at least one of the one or more objects, the one or more data entities, the links between the one or more objects and the one or more data entities, and the relationships between the one or more objects and the one or more data entities. Thereafter, the knowledge graph generating module 215 aggregates at least one object and at least one data entity based on the computation. Subsequently, the knowledge graph generating module 215 determines relationship between the at least one object and the at least one data entity based on the aggregated at least one object and the at least one data entity to generate a plurality of directed acyclic graphs. The directed acyclic graph indicates a connection between an object of the one or more objects and a data entity of the one or more data entities based on their relationship. The object is a source node and the data entity is a target node in the directed acyclic graph. Lastly, the knowledge graph generating module 215 generates a dynamic data tree structure using the plurality of directed acyclic graphs to generate the knowledge graph. Each node in the dynamic data tree structure contains a weightage score as an attribute information.

The knowledge graph generating module 215 filters nodes with less than a pre-determined number of node connections in the dynamic data tree structure.

The sub-graph feature generating module 217 generates a set of sub-graphs from the knowledge graph based on a number of node connections in the knowledge graph using the unsupervised machine learning technique.

The structure generating module 219 extracts graph data structure information for each sub-graph in the set of sub-graphs. The graph data structure information presents the training content to the root cause classifier module 221.

The root cause classifier module 221 generates a root cause model based on the set of sub-graphs and the graph data structure information for each sub-graph using a graph convolutional network. Furthermore, the root cause classifier module 221 determines the core problem in the input content. This core problem determination helps in identifying the respective sub-graph where further analysis is required to determine the cause and effect. The root cause classifier module 221 sends the list of main root causes and the root cause model to the sub-graph cluster generating module 223.

The sub-graph cluster generating module 223 generates at least one sub-graph cluster and corresponding probabilistic graphical model using the root cause model and the knowledge graph. Here, a sub-graph cluster is a collection of sub-graphs relating to a sub-domain In detail, the sub-graph cluster generating module 223 receive the input on list of several types of main root cause types that determined by the root cause classifier module 221. Using this received information, the sub-graph cluster generating module 223 directly refers to the distinct types of sub-cluster groups that need to be generated. In an embodiment, the sub-cluster is identified using a semi-supervised technique. In an embodiment, the list of factors that led to the issue to the main issue or RCA to occur is determined by the sub-graph cluster generating module 223. Furthermore, the sub-graph cluster generating module 223 trains the probabilistic graphical model to each new sub-graph cluster. The probabilistic graphical model is trained on the conditional probability distributions and on likelihood estimation. The sub-graph cluster generating module 223 assigns weightage factor for the at least one sub-graph cluster using a trained probabilistic graphical model.

In an embodiment, the sub-graph cluster generating module 223 stores at least one of the knowledge graph, the root cause model and the information related to the at least one sub-graph cluster and the corresponding probabilistic graphical model for each of the sub-graph cluster in the database 103.

The RCA predicting module 225 determines a root cause for an issue from the extracted plurality of features by the pre-processing module 213, during RCA phase or issue resolving phase, using the knowledge graph, the root cause model and the information related to the at least one sub-graph cluster and corresponding probabilistic graphical model for each of the sub-graph cluster stored in the database 103. In detail, the RCA predicting module 225 receives the stored information such as the knowledge graph, the root cause model and the information related to the at least one sub-graph cluster and the corresponding probabilistic graphical model for each of the sub-graph cluster from the database 103. After receiving the stored information, the RCA system 107 determines the (core) root cause against the issue that is received in the issue content. This represents an intermediate output that provides the indication on the next step sub-graph cluster that needs to be executed in order to determine the causes or facts that led to the problem/issue. After determining the (core) root cause, the RCA predicting module 225 identifies the sub-graphs associated with the (core) root cause and determines a list of issues associated with the root cause.

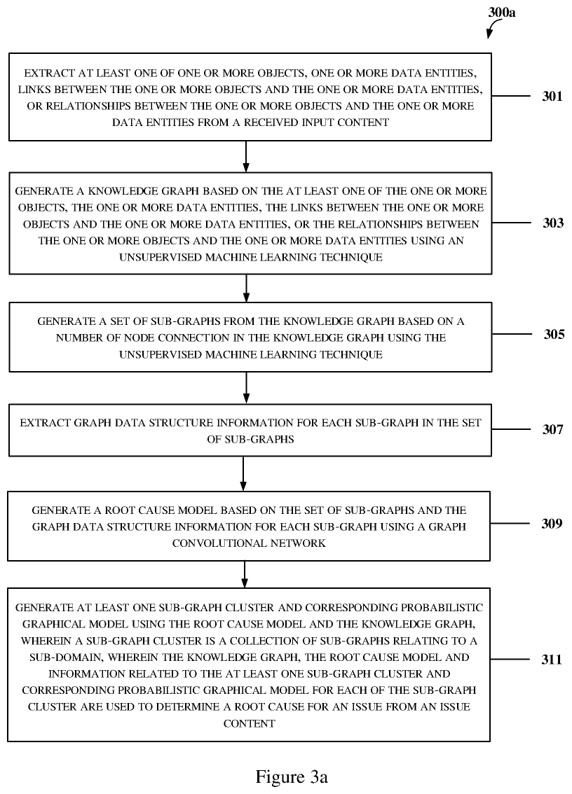

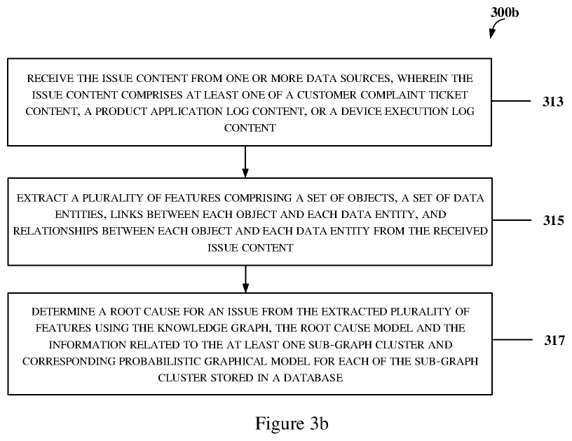

FIG. 3a illustrates a flowchart showing a method of generating a knowledge graph and sub-graph clusters to perform a root cause analysis in accordance with some embodiments of present disclosure.

As illustrated in FIG. 3a, the method 300a includes one or more blocks for generating a knowledge graph and sub-graph clusters to perform a root cause analysis. The method 300a may be described in the general context of computer executable instructions. Generally, computer executable instructions can include routines, programs, objects, components, data structures, procedures, modules, and functions, which perform particular functions or implement particular abstract data types.

The order in which the method 300a is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the pre-processing module 213 of the RCA system 107 may extract at least one of one or more objects, one or more data entities, links between the one or more objects and the one or more data entities, or relationships between the one or more objects and the one or more data entities from a received input content. The received input content may comprise at least one of a customer complaint ticket content, a product application log content, a device execution log content, or a text corpus. The text corpus may comprise at least one of a product documentation, a product specification, a product feature, a product manual, product support information with issues and resolutions or a troubleshooting procedure.

At block 303, the knowledge graph generating module 215 of the RCA system 107 may generate a knowledge graph based on the at least one of the one or more objects, the one or more data entities, the links between the one or more objects and the one or more data entities, or the relationships between the one or more objects and the one or more data entities extracted at block 301 using an unsupervised machine learning technique.

At block 305, the sub-graph feature generating module 217 of the RCA system 107 may generate a set of sub-graphs from the knowledge graph generated at block 303 based on a number of node connections in the knowledge graph using the unsupervised machine learning technique.

At block 307, the structure generating module 219 of the RCA system 107 may extract graph data structure information for each sub-graph in the set of sub-graphs generated at block 305.

At block 309, the root cause classifier module 221 of the RCA system 107 may generate a root cause model based on the set of sub-graphs extracted at block 305 and the graph data structure information for each sub-graph extracted at block 307 using a graph convolutional network.

At block 311, the sub-graph cluster generating module 223 of the RCA system 107 may generate at least one sub-graph cluster and corresponding probabilistic graphical model using the root cause model generated at block 309 and the knowledge graph generated at block 303. A sub-graph cluster may be a collection of sub-graphs relating to a sub-domain.

The knowledge graph, the root cause model, and information related to the at least one sub-graph cluster and corresponding probabilistic graphical model for each of the sub-graph cluster may be used to determine a root cause for an issue from an issue content.

FIG. 3b illustrates a flowchart showing a method of performing a root cause analysis using the method illustrated in FIG. 3a in accordance with some embodiments of present disclosure.

As illustrated in FIG. 3b, the method 300b includes one or more blocks for performing a root cause analysis using the method illustrated in FIG. 3a. The method 300b may be described in the general context of computer executable instructions. Generally, computer executable instructions can include routines, programs, objects, components, data structures, procedures, modules, and functions, which perform particular functions or implement particular abstract data types.

The order in which the method 300b is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 313, the pre-processing module 213 of the RCA system 107 may receive the issue content from one or more data sources. The issue content comprises at least one of a customer complaint ticket content, a product application log content, or a device execution log content.

At block 315, the pre-processing module 213 of the RCA system 107 may extract a plurality of features comprising a set of objects, a set of data entities, links between each object and each data entity, and relationships between each object and each data entity from the received issue content.

At block 317, the RCA predicting module 225 of the RCA system 107 may determine a root cause for an issue from the extracted plurality of features at block 315 using the knowledge graph, the root cause model and information related to the at least one sub-graph cluster and corresponding probabilistic graphical model for each of the sub-graph cluster stored in a database 103.

Some of the advantages of the present disclosure are listed below.

The present disclosure provides an improved and efficient method and an RCA system that dynamically performs knowledge graph and sub-graph clusters based RCA. The domain learning is represented in terms of knowledge graph and sub-graph clusters. The knowledge graph and the sub-graph clusters are generated in a similar line to human intelligence using the unsupervised machine learning technique and probabilistic inference for RCA. In doing so, the present disclosure addresses following existing problems:
Conventionally, human intelligence is required to build RCA solutions that are specific to a particular (technical and/or business) domain. The present disclosure provides a generic RCA solution to cater to all technical and/or business problems irrespective of their domain.
To perform RCA automation, historical data is required, and the solution detects only the past RCA findings that is trained on the system. The present disclosure intuitively learns new RCA findings while processing and also, learns the unknown facts and derive new facts that are not known during the training phase.
RCA is evolving to changes in the environment. Any artificial intelligence system using supervised technique that is trained for specific data will not be able to meet the growing demand for the changes that evolved in the environment. The present disclosure applies unsupervised machine learning technique along with knowledge graph and sub-graph clusters for adapting to the changes that evolves in the technical and/or business domain environment.

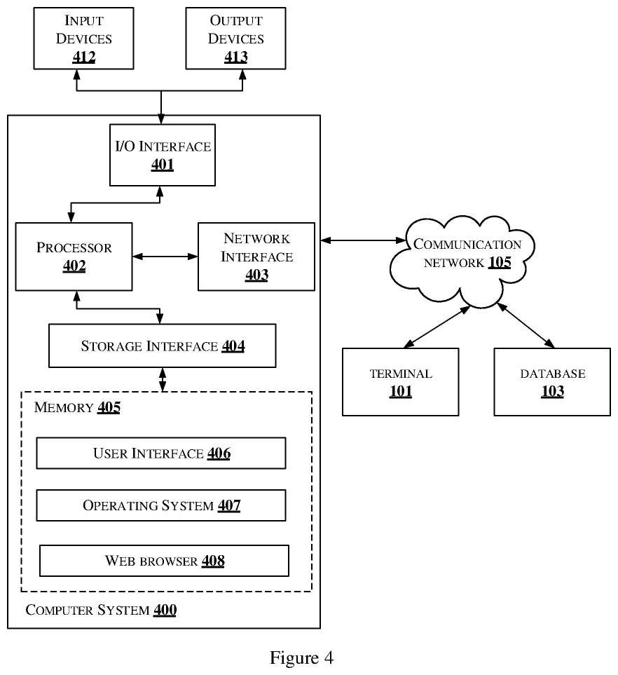

FIG. 4 illustrates a block diagram of an exemplary computer system 400 for implementing embodiments consistent with the present disclosure. In an embodiment, the computer system 400 may be used to implement the RCA system 107. The computer system 400 may include a central processing unit (“CPU” or “processor”) 402. The processor 402 may include at least one data processor for generating a knowledge graph and sub-graph clusters to perform a RCA. The processor 402 may include specialized processing units such as, integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

Using the I/O interface 401, the computer system 400 may communicate with one or more I/O devices such as input devices 412 and output devices 413. For example, the input devices 412 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 413 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 400 consists of the RCA system 107. The processor 402 may be disposed in communication with the communication network 105 via a network interface 403. The network interface 403 may communicate with the communication network 105. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. The communication network 105 may include, without limitation, a direct interconnection, Local Area Network (LAN), Wide Area Network (WAN), wireless network (e.g., using Wireless Application Protocol), the Internet, etc. Using the network interface 403 and the communication network 105, the computer system 400 may communicate with the terminal 101 and the database 103. The network interface 403 may employ connection protocols include, but not limited to, direct connect, Ethernet (e.g., twisted pair 10/100/1000 Base T), Transmission Control Protocol/Internet Protocol (TCP/IP), token ring, IEEE® 802.11a/b/g/n/x, etc.

The communication network 105 includes, but is not limited to, a direct interconnection, a Peer to Peer (P2P) network, Local Area Network (LAN), Wide Area Network (WAN), wireless network (e.g., using Wireless Application Protocol), the Internet, Wi-Fi and such.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, Serial Advanced Technology Attachment (SATA), Integrated Drive Electronics (IDE), IEEE®-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, etc. In some embodiments, computer system 400 may store user/application data, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA/7/8, 10 etc.), APPLE® IOS®, GOOGLE™ ANDROID™, BLACKBERRY® OS, or the like.

In some embodiments, the computer system 400 may implement web browser 408 stored program components. Web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. The computer system 400 may implement a mail server (not shown in FIG. 4) stored program component. The mail server may be an Internet mail server such as Microsoft Exchange, or the like. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. The computer system 400 may implement a mail client (not shown in FIG. 4) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3a and 3b show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| number | Description |
| 100 | Environment |
| 101 | Terminal |
| 103 | Database |
| 105 | Communication network |
| 107 | Root cause analysis system |
| 111 | I/O interface |
| 113 | Memory |
| 115 | Processor |
| 200 | Data |
| 201 | Input data |
| 203 | Other data |
| 211 | Modules |
| 213 | Pre-processing module |
| 215 | Knowledge graph |
| | generating module |
| 217 | Sub-graph feature |
| | generating module |
| 219 | Structure generating |
| | module |
| 221 | Root cause classifier |
| | module |
| 223 | Sub-graph cluster |
| | generating module |
| 225 | RCA predicting module |
| 227 | Other modules |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 412 | Input devices |
| 413 | Output devices |

What is claimed is:

1. A method of generating a knowledge graph and sub-graph clusters to perform a root cause analysis, the method comprising:
extracting, by a Root Cause Analysis (RCA) system, at least one of one or more objects, one or more data entities, links between the one or more objects and the one or more data entities, or relationships between the one or more objects and the one or more data entities from a received input content;
generating, by the RCA system, a knowledge graph based on the at least one of the one or more objects, the one or more data entities, the links between the one or more objects and the one or more data entities, or the relationships between the one or more objects and the one or more data entities using an unsupervised machine learning technique;
generating, by the RCA system, a set of sub-graphs from the knowledge graph based on a number of node connections in the knowledge graph using the unsupervised machine learning technique;
extracting, by the RCA system, graph data structure information for each sub-graph in the set of sub-graphs;
generating, by the RCA system, a root cause model based on the set of sub-graphs and the graph data structure information for each sub-graph using a graph convolutional network; and
generating, by the RCA system, at least one sub-graph cluster and corresponding probabilistic graphical model using the root cause model and the knowledge graph, wherein a sub-graph cluster is a collection of sub-graphs relating to a sub-domain,
wherein the knowledge graph, the root cause model and information related to the at least one sub-graph cluster and corresponding probabilistic graphical model for each of the sub-graph cluster are used to determine a root cause for an issue from an issue content.

2. The method as claimed in claim 1, wherein generating the knowledge graph using the unsupervised machine learning technique comprises:
computing, by the RCA system, cosine similarity between each of the at least one of the one or more objects, the one or more data entities, the links between the one or more objects and the one or more data entities, and the relationships between the one or more objects and the one or more data entities;
aggregating, by the RCA system, at least one object and at least one data entity based on the computation;
determining, by the RCA system, relationship between the at least one object and the at least one data entity based on the aggregated at least one object and the at least one data entity to generate a plurality of directed acyclic graphs, wherein the directed acyclic graph indicates a connection between an object of the one or more objects and a data entity of the one or more data entities based on their relationship; and
generating, by the RCA system, a dynamic data tree structure using the plurality of directed acyclic graphs to generate the knowledge graph, wherein the object is a source node and the data entity is a target node in the directed acyclic graph and, wherein each node in the dynamic data tree structure contains a weightage score as an attribute information.

3. The method as claimed in claim 2, wherein generating the knowledge graph further comprises:
filtering, by the RCA system, nodes with less than a pre-determined number of node connections in the dynamic data tree structure.

4. The method as claimed in claim 1, wherein generating the at least one sub-graph cluster and corresponding probabilistic graphical model using the root cause model and the knowledge graph comprises:
assigning, by the RCA system, weightage factor for the at least one sub-graph cluster using a trained probabilistic graphical model,
wherein the trained probabilistic graphical model is trained on conditional probability distributions and on likelihood estimation.

5. The method as claimed in claim 1, further comprising:
storing, by the RCA system, at least one of the knowledge graph, the root cause model and the information related to the at least one sub-graph cluster and the corresponding probabilistic graphical model for each of the sub-graph cluster in a database.

6. The method as claimed in claim 1, further comprising:
receiving, by the RCA system, the issue content from one or more data sources, wherein the issue content comprises at least one of a customer complaint ticket content, a product application log content, or a device execution log content;
extracting, by the RCA system, a plurality of features comprising a set of objects, a set of data entities, links between each object and each data entity, and relationships between each object and each data entity from the received issue content; and
determining, by the RCA system, a root cause for an issue from the extracted plurality of features using the knowledge graph, the root cause model and the information related to the at least one sub-graph cluster and corresponding probabilistic graphical model for each of the sub-graph cluster stored in a database.

7. A Root Cause Analysis (RCA) system for generating a knowledge graph and sub-graph clusters to perform a root cause analysis, the RCA system comprising:
a processor; and
a memory communicatively coupled to the processor, wherein the memory stores processor-executable instructions, which on execution, cause the processor to:
extract at least one of one or more objects, one or more data entities, links between the one or more objects and the one or more data entities, or relationships between the one or more objects and the one or more data entities from a received input content;
generate a knowledge graph based on the at least one of the one or more objects, the one or more data entities, the links between the one or more objects and the one or more data entities, or the relationships between the one or more objects and the one or more data entities using an unsupervised machine learning technique;
generate a set of sub-graphs from the knowledge graph based on a number of node connections in the knowledge graph using the unsupervised machine learning technique;
extract graph data structure information for each sub-graph in the set of sub-graphs;
generate a root cause model based on the set of sub-graphs and the graph data structure information for each sub-graph using a graph convolutional network; and
generate at least one sub-graph cluster and corresponding probabilistic graphical model using the root cause model and the knowledge graph, wherein a sub-graph cluster is a collection of sub-graphs relating to a sub-domain,
wherein the knowledge graph, the root cause model and information related to the at least one sub-graph cluster and corresponding probabilistic graphical model for each of the sub-graph cluster are used to determine a root cause for an issue from an issue content.

8. The RCA system as claimed in claim 7, wherein the processor-executable instructions cause the processor to:
compute cosine similarity between each of the at least one of the one or more objects, the one or more data entities, the links between the one or more objects and the one or more data entities, and the relationships between the one or more objects and the one or more data entities;
aggregate at least one object and at least one data entity based on the computation;
determine relationship between the at least one object and the at least one data entity based on the aggregated at least one object and the at least one data entity to generate a plurality of directed acyclic graphs, wherein the directed acyclic graph indicates a connection between an object of the one or more objects and a data entity of the one or more data entities based on their relationship; and
generate a dynamic data tree structure using the plurality of directed acyclic graphs to generate the knowledge graph, wherein the object is a source node and the data entity is a target node in the directed acyclic graph, and wherein each node in the dynamic data tree structure contains a weightage score as an attribute information.

9. The RCA system as claimed in claim 8, wherein the processor-executable instructions further cause the processor to generate the knowledge graph by:
filtering nodes with less than a pre-determined number of node connections in the dynamic data tree structure.

10. The RCA system as claimed in claim 7, wherein the processor-executable instructions cause the processor to generate the at least one sub-graph cluster and corresponding probabilistic graphical model using the root cause model and the knowledge graph by:
assigning weightage factor for the at least one sub-graph cluster using a trained probabilistic graphical model,
wherein the trained probabilistic graphical model is trained on conditional probability distributions and on likelihood estimation.

11. The RCA system as claimed in claim 7, wherein the processor-executable instructions further cause the processor to:
store at least one of the knowledge graph, the root cause model and the information related to the at least one sub-graph cluster and the corresponding probabilistic graphical model for each of the sub-graph cluster in a database.

12. The RCA system as claimed in claim 7, wherein the processor-executable instructions further cause the processor to:
receive the issue content from one or more data sources, wherein the issue content comprises at least one of a customer complaint ticket content, a product application log content, or a device execution log content;
extract a plurality of features comprising a set of objects, a set of data entities, links between each object and each data entity, and relationships between each object and each data entity from the received issue content; and
determine a root cause for an issue from the extracted plurality of features using the knowledge graph, the root cause model and the information related to the at least one sub-graph cluster and corresponding probabilistic graphical model for each of the sub-graph cluster stored in a database.

13. A non-transitory computer readable medium including instructions stored thereon that when processed by at least one processor cause a Root Cause Analysis (RCA) system to perform operations comprising:
extracting at least one of one or more objects, one or more data entities, links between the one or more objects and the one or more data entities, or relationships between the one or more objects and the one or more data entities from a received input content;
generating a knowledge graph based on the at least one of the one or more objects, the one or more data entities, the links between the one or more objects and the one or more data entities, or the relationships between the one or more objects and the one or more data entities using an unsupervised machine learning technique;
generating a set of sub-graphs from the knowledge graph based on a number of node connections in the knowledge graph using the unsupervised machine learning technique;
extracting graph data structure information for each sub-graph in the set of sub-graphs;
generating a root cause model based on the set of sub-graphs and the graph data structure information for each sub-graph using a graph convolutional network; and
generating at least one sub-graph cluster and corresponding probabilistic graphical model using the root cause model and the knowledge graph, wherein a sub-graph cluster is a collection of sub-graphs relating to a sub-domain,
wherein the knowledge graph, the root cause model and information related to the at least one sub-graph cluster and corresponding probabilistic graphical model for each of the sub-graph cluster are used to determine a root cause for an issue from an issue content.

14. The medium as claimed in claim 13, wherein the instructions when processed by the at least one processor cause the RCA system to perform operations comprising:
computing cosine similarity between each of the at least one of the one or more objects, the one or more data entities, the links between the one or more objects and the one or more data entities, and the relationships between the one or more objects and the one or more data entities;
aggregating at least one object and at least one data entity based on the computation;
determining relationship between the at least one object and the at least one data entity based on the aggregated at least one object and the at least one data entity to generate a plurality of directed acyclic graphs, wherein the directed acyclic graph indicates a connection between an object of the one or more objects and a data entity of the one or more data entities based on their relationship; and
generating a dynamic data tree structure using the plurality of directed acyclic graphs to generate the knowledge graph, wherein the object is a source node and the data entity is a target node in the directed acyclic graph and, wherein each node in the dynamic data tree structure contains a weightage score as an attribute information.

15. The medium as claimed in claim 14, wherein the instructions when processed by the at least one processor cause the RCA system to generate the knowledge graph by:
filtering nodes with less than a pre-determined number of node connections in the dynamic data tree structure.

16. The medium as claimed in claim 13, wherein the instructions when processed by the at least one processor cause the RCA system to generate the at least one sub-graph cluster and corresponding probabilistic graphical model using the root cause model and the knowledge graph by:
assigning weightage factor for the at least one sub-graph cluster using a trained probabilistic graphical model,
wherein the trained probabilistic graphical model is trained on conditional probability distributions and on likelihood estimation.

17. The medium as claimed in claim 13, wherein the instructions when processed by the at least one processor cause the RCA system to perform operations comprising:
storing at least one of the knowledge graph, the root cause model and the information related to the at least one sub-graph cluster and the corresponding probabilistic graphical model for each of the sub-graph cluster in a database.

18. The medium as claimed in claim 13, wherein the instructions when processed by the at least one processor cause the RCA system to perform operations comprising:
receiving the issue content from one or more data sources, wherein the issue content comprises at least one of a customer complaint ticket content, a product application log content, or a device execution log content;
extracting a plurality of features comprising a set of objects, a set of data entities, links between each object and each data entity, and relationships between each object and each data entity from the received issue content; and
determining a root cause for an issue from the extracted plurality of features using the knowledge graph, the root cause model and the information related to the at least one sub-graph cluster and corresponding probabilistic graphical model for each of the sub-graph cluster stored in a database.
